(19) United States
(12) Patent Application Publication
(10) Pub. No.: US 2011/0109925 A1
(43) Pub. Date: May 12, 2011

(54) CORRECTION UNIT FOR COLOR MEASUREMENT UNIT MOUNTED IN PRINTING APPARATUS AND CORRECTION LUT FOR COLOR MEASUREMENT UNIT

(75) Inventor: Jun Hoshii, Shiojiri-shi (JP)

(73) Assignee: SEIKO EPSON CORPORATION, Shinjuku-ku (JP)

(21) Appl. No.: 12/940,892

(22) Filed: Nov. 5, 2010

(30) Foreign Application Priority Data
Nov. 6, 2009 (JP) 2009-255343

(51) Int. Cl. H04N 1/60

(52) U.S. Cl. 358/1.9

(57) ABSTRACT

In creating a correction LUT that includes, as its data, correction values each equivalent to a difference between a color-measurement value measured by a spectroreflectometer as a reference color measurement unit and a color-measurement value measured by a spectroreflectometer as a correction-target color measurement unit, the correction LUT includes, as its argument elements, a wavelength, reflectance, a change in reflectivity relative to wavelength, obtains the correction values based on the color measurement results of color patches each corresponding to a predetermined color, and estimates a correction value at a grid point lacking the correction value based on the color measurement results.

### INCORPORATED BY REFERENCE

The entire disclosure of Japanese Patent Application No. 2009-255343, filed Nov. 6, 2009 is expressly incorporated by reference herein.

### BACKGROUND

1. Technical Field

The present invention relates to a correction unit for a color measurement unit mounted in a printing apparatus and a correction LUT for a color measurement unit.

2. Related Art

Accuracy of a color measurement unit plays an important role in the process of improvement of printing resolution (color reproduction) in a printing apparatus.

In general, a color measurement unit is used as a tool having accuracy that meets certain criteria. However, “Diagnosing and Correcting Systematic Errors in Spectral-Based Digital Imaging” at “13^{th} Color Imaging Conference Final Program and Proceedings” held on 7^{th}-11^{th} Nov., 2005, discloses a wavelength scale error as an error caused by a mechanical factor, which is one of the reasons for variation in accuracy among color measurement units.

Further, it is disclosed that the wavelength scale error is classified into a linear error and a non-linear error with respect to the wavelength, and a change in reflectivity relative to wavelength, i.e., a derivative of the reflectance, is a factor in an error component.

Although analysis has been made on existing errors caused by the change in reflectivity relative to wavelength, in the research on variations among color measurement units, how to remove the error component mentioned above has not yet been disclosed.

### SUMMARY

An advantage of some aspects of the invention is to make it possible to perform color correction in which differences of individual color measurement units are taken into consideration.

In order to achieve the above advantage, an aspect of the invention provides a correction unit that corrects a color measurement unit mounted in a printing apparatus, and the correction unit includes a correction LUT in which a correction value equivalent to a difference between a color-measurement value measured by a reference color measurement unit and a color-measurement value measured by a color measurement unit to be calibrated (hereinafter referred to as a correction-target color measurement unit) is provided for look-up. The correction LUT includes a wavelength, reflectance, and a change in reflectivity relative to wavelength as its argument elements, obtains the correction value based on a color measurement result of a patch corresponding to a predetermined color, and also estimates a correction value at a grid point which lacks the aforementioned correction value, the estimation being carried out referring to the actual color measurement results.

Specifically, in order to calibrate the color measurement unit mounted in the printing apparatus, the aspect of the invention uses the correction LUT that includes correction values each equivalent to a difference between a color-measurement value measured by the reference color measurement unit and a color-measurement value measured by the correction-target color measurement unit. This correction LUT includes, as its argument elements, a wavelength, reflectance, and a change in reflectivity relative to wavelength. Note that the correction LUT uses not only the wavelength and reflectance but also the change in reflectivity relative to wavelength as its argument elements. Further, correction values are obtained based on color measurement results of patches each corresponding to a predetermined color. However, some grid points lacking a color-measurement value appear in the correction LUT. Since the appearance of such grid points cannot be suppressed only by the color measurement of the patches, a correction value at a grid point lacking the color-measurement value is estimated referring to the actual color measurement results.

It is preferable that the correction LUT include: a patch printing unit that prints a predetermined patch in the printing apparatus; a spectral reflectance obtaining unit that performs color measurement on the patch to obtain a spectral reflectance using the reference color measurement unit; a spectral reflectance obtaining unit that performs color measurement on the patch to obtain a spectral reflectance using the correction-target color measurement unit; a patch difference obtaining unit that obtains a difference in the spectral reflectance between the reference color measurement unit and the correction-target color measurement unit for respective patch; a change-in-reflectivity difference obtaining unit that specifies a correspondence relationship between the change and the difference values through making use of the color measurement results having the same wavelength and reflectance from the total color measurement results of all the patches; and a correction LUT creation unit that creates the correction LUT using, as argument elements, a wavelength, reflectance, and the change corresponding to the specified results described above.

To be more specific, the printing apparatus prints a predetermined patch and both the reference color measurement unit and the correction-target color measurement unit perform color measurement on the printed patch. Next, based on the measured color-measurement values of the patches, a difference in the spectral reflectance between the reference color measurement unit and the correction-target color measurement unit is obtained for respective patch. In addition, from the total color measurement results of all the patches, a correspondence relationship between the change and the difference values is specified through making use of the measurement results having the same wavelength and reflectance. Finally, the correction LUT is created using, as argument elements, the wavelength, reflectance, and the change corresponding to the specified relationship described above. At this time, a correction value is estimated at a grid point lacking a color measurement result in the LUT from the correction values of other grid points in the LUT.

Furthermore, in dealing with a grid point in the above correction LUT that lacks a correspondence relationship to the difference value while having a color measurement result of the wavelength and reflectance, but not having a color measurement result of the change, it is preferable that the change-in-reflectivity difference obtaining unit smoothly connect such a grid point to other grid points based on the difference values obtained according to the previously-measured change so as to estimate the correction value at the above mentioned grid point.

More specifically, there are several cases in which color-measurement values are in lack; these cases can cause the lack of a correction value at related grid points in the LUT. Among such grid points, a correction value is estimated at a grid point, which has a color measurement result of the wavelength and reflectance but does not have a measurement result of the change, by smoothly connecting the grid point to other grid points based on the difference values obtained according to the previously-measured change in reflectivity.

In dealing with a grid point that has a color measurement result of the wavelength and reflectance but lacks a color measurement result of the change, it is preferable that the change-in-reflectivity difference obtaining unit estimate a correction value at the grid point, if there are two differences having different changes, from the difference at the largest change and the difference at the smallest change.

That is to say, in a case where there are two differences having different changes, the new difference may be estimated from the difference at the largest change and the difference at the smallest change for each grid point corresponding to the change.

Furthermore, it is preferable that the change-in-reflectivity difference obtaining unit estimate a difference at a grid point that does not have a color measurement result of the wavelength and reflectance through interpolation operation using the differences of other grid points which have the color measurement results of the wavelength and reflectance.

In other words, in a case where there is a grid point that lacks a color measurement result of the wavelength and reflectance, the difference of the grid is estimated through interpolation operation using the differences at other grid points which have the color measurement results of the wavelength and reflectance.

It is preferable that the correction LUT include a wavelength, reflectance, a change in reflectivity, and a change of the change in reflectivity, as its argument elements.

In other words, the argument elements of the correction LUT may include a change of the change in reflectivity in addition to those described above.

Further, it is preferable that the correction LUT creation unit lessen the degree of weighting onto a color-measurement value in a region where brightness is low when it estimates the correction value.

According to another aspect of the invention, a correction LUT may include correction values each equivalent to a difference between a color-measurement value measured by a reference color measurement unit and a color-measurement value measured by a correction-target color measurement unit. At this time, the correction LUT includes, as its argument elements, a wavelength, reflectance, and a change in reflectivity relative to wavelength; the correction values are obtained based on the color measurement results of patches each corresponding to a predetermined color; and a correction value is estimated at a grid point which lacks the correction value based on the color measurement results described above.

The aspect of the invention may be applied to a printing apparatus in which a color measurement unit is mounted. That is, the aspect of the invention can be applied in the case where color reproduction of printing is corrected in accordance with the color measurement result provided by the color measurement unit. Furthermore, the aspect of the invention can be applied to such apparatuses as a print control apparatus and a color correction apparatus in the sense that print colors of the printing apparatus are corrected. As explained thus far, the application range of the invention is not limited to the scope of the invention.

The invention does not necessarily need to be limited to a tangible apparatus, and it is understood with ease that the aspect of the invention functions as a method of operation. Therefore, the aspect of the invention is useful not only as a tangible apparatus but also as a method of operation.

An apparatus according to the aspect of the invention can operate independently or operate being embedded in other apparatus, and so on; in addition, the spirit of the invention can be embodied in a wide variety of applications. They can be configured of hardware and/or software, and their configurations can be adequately changed.

In the case where the spirit of the invention is embodied in a form of software, it is definitely true that the spirit of the invention resides in a recording medium storing the software to be actually used.

Of course, the recording medium can be a magnetic or magneto-optical recording medium, and any recording medium which will be developed in the future can be considered the same as the currently available recording media. Needless to say, products in copy process such as a first-time duplication product or second-time duplication product are also considered the same as mentioned above. In addition, even if the software is delivered through a communications network, it makes no difference in the sense that the aspect of the invention is used.

Furthermore, even if the aspect of the invention is embodied partly by software and partly by hardware, it is definitely within the spirit of the invention, and an embodiment in this case may take a configuration such that part of the system is stored in a recording medium and is read out therefrom into the system when needed.

In the case where the aspect of the invention is embodied by software, the embodiment may take a configuration capable of using hardware and an operating system, or may take a configuration which is separated from the hardware and the operating system. For example, in various types of calculation, some case can be carried out by calling a predetermined function from the operating system, and other case can be input to the hardware without calling such a function. Even if these calculation operations are actually implemented through the operating system, as far as a program is recorded in a recording medium and in the process of distribution, it can be understood that the aspect of the invention is embodied only by this program.

In addition, in the case where the aspect of the invention is embodied by software, it is obvious that the aspect of the invention is substantiated not only as a recording medium which records a program but also as a program itself, and the program is, of course, included in the invention.

### BRIEF DESCRIPTION OF THE DRAWINGS

The aspects of the invention will be described with reference to the accompanying drawings, wherein like numbers reference like elements.

FIG. 1 is a block diagram illustrating a print control apparatus including a correction unit for a color measurement unit according to an aspect of the invention.

FIG. 2 is a flowchart according to the aspect of the invention.

FIG. 3 is a diagram illustrating a wavelength, reflectance, and a difference in reflectivity (gradient).

FIG. 4 is a diagram illustrating a correspondence between a color measurement result and a difference for respective patch.

FIG. 5 is a diagram indicating presence/absence of a difference (correction value) for each wavelength and reflectance.

FIG. 6 is a diagram illustrating an interpolation process to obtain a correction value at a grid point lacking the correction value from the correction values at other grid points.

FIG. 7 is a diagram illustrating an estimation manner in the case there is one correction value.

FIG. 8 is a diagram illustrating an estimation manner in the case where there are two correction values.

FIG. 9 is a diagram illustrating an estimation manner in the case where there are three or more correction values.

FIG. 10 is a diagram indicating a relationship between a wavelength and reflectance.

### DESCRIPTION OF EXEMPLARY EMBODIMENTS

Hereinafter, exemplary embodiments of the invention will be described with reference to the accompanying drawings in order as shown below.

### 1. Configuration of Correction Unit for Color Measurement Unit

### 2. Correction LUT Creation Process

### 3. Modifications

### 1. Configuration of Correction Unit for Color Measurement Unit

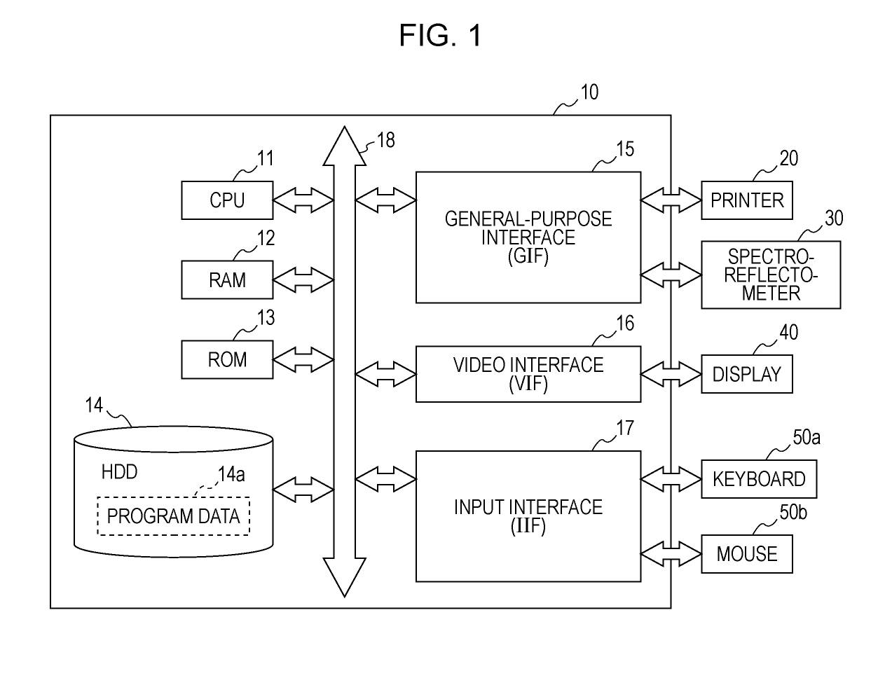

FIG. 1 illustrates a hardware configuration of a print control apparatus including a correction unit for a color measurement unit according to an embodiment of the invention. In FIG. 1, the print control apparatus is mainly configured of a computer 10. The computer 10 includes a CPU 11, a RAM 12, a ROM 13, a hard disk drive (HDD) 14, a general-purpose interface (GIF) 15, a video interface (VIF) 16, an input interface (IIF) 17 and a bus 18. The bus 18 implements data communications among the components 11-17 in the computer 10, and its communications control function is supported by a chipset (not shown) and the like. The HDD 14 stores program data 14a to execute various kinds of programs including an operating system (OS). The CPU 11 carries out operations in accordance with the program data 14a while loading the program data 14a into the RAM 12. The GIF 15 provides an interface conforming to the USB standards, for example, and is used for connecting an external printer 20 and a spectroreflectometer 30 to the computer 10. The VIF 16 connects an external display 40 to the computer 10 and provides an interface to display images on the display 40. The IIF 17 connects an external keyboard 50a and mouse 50b to the computer 10 and provides an interface for the computer 10 to receive input signals from the keyboard 50a and mouse 50b.

The external printer (printing apparatus) 20 and the spectroreflectometer 30 can be separated from each other or can be integrated into one single apparatus. Recently, apparatuses integrating a printer and a spectral reflectance meter have been developed to achieve high-resolution print reproduction. Either of the two apparatus types, one is a separation-type, the other one is an integration-type, can be used in the embodiment.

The spectroreflectometer 30 corresponds to both a reference color measurement unit and a correction-target color measurement unit. The spectroreflectometer 30 as a reference color measurement unit may actually perform color measurement as needed or may use instead a previously-measured color measurement result without performing actual color measurement.

### 2. Correction LUT Creation Process

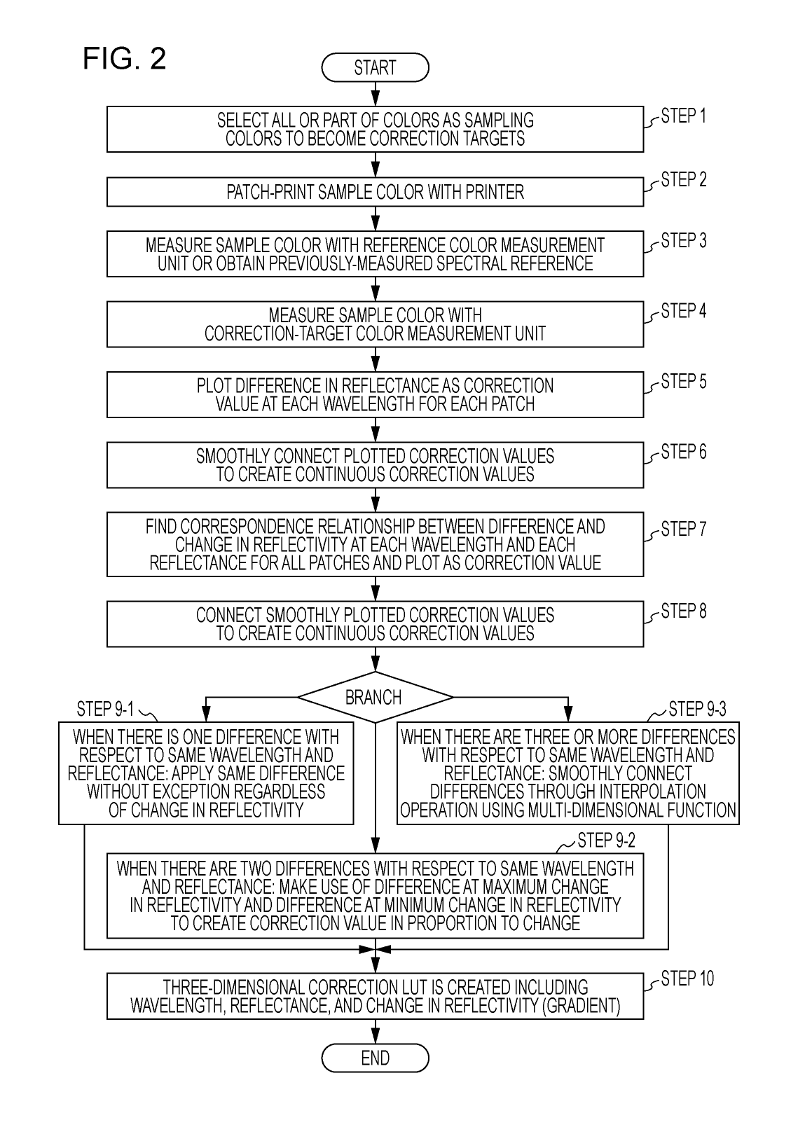

FIG. 2 illustrates a flowchart to create a correction LUT for the color measurement unit. The correction LUT is used to refer to a correction value equivalent to a difference between a color-measurement value measured by the reference color measurement unit and a color-measurement value measured by the correction-target color measurement unit.

This embodiment is a system in which the spectroreflectometer 30 performs color measurement on print results on a timely basis, and the printer 20 is calibrated according to the color measurement result so that the printer 20 can print predetermined specified-colors with desired reproduction accuracy. At this time, in order to calibrate the color measurement result read by the spectroreflectometer 30, the correction LUT is created whose constituent is a difference between a color-measurement value measured by the reference color measurement unit and a color-measurement value measured by the spectroreflectometer 30.

In step 1, all or part of the colors, which will be used for calibration, are selected for sample colors. In this step, all or part of the predetermined specified-colors mentioned above are decided to be targets for color measurement.

In step 2, the printer 20 prints a patch of each of the sample colors which have been extracted as described above. The patch is printed based on the data corresponding to ink color so as to achieve a color reproduction with high-accuracy. Note that steps 1 and 2 correspond to the patch printing unit.

In step 3, the spectroreflectometer 30 as the reference color measurement unit measures a sample color patch. However, since the color measurement result read by the reference color measurement unit is constant, previously-measured spectral reflectance data can be used if available. Note that step 3 corresponds to the step executed in the spectral reflectance obtaining unit using a reference color measurement unit.

In step 4, a sample color patch is measured by the spectroreflectometer 30 of the correction-target color measurement unit. The result obtained in this step is a color measurement result read by the spectroreflectometer 30 which is the target for calibration. Note that step 4 corresponds to the step executed in the spectral reflectance obtaining unit using a correction-target color measurement unit.

In step 5, a difference in reflectivity at each wavelength is plotted as a correction value for respective patch.

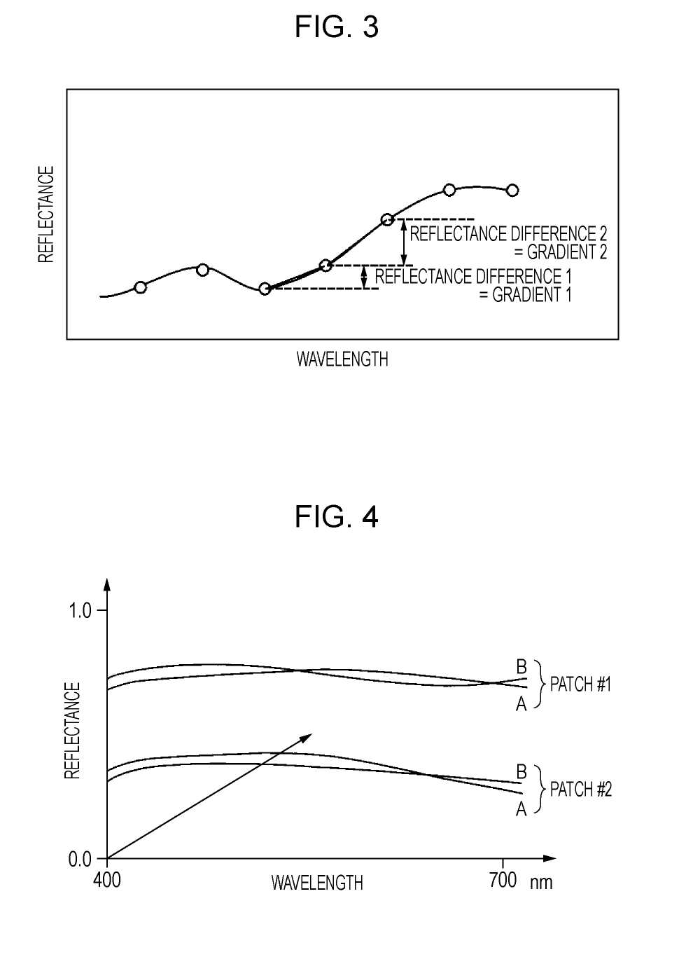

FIG. 3 is a diagram illustrating correspondence between a wavelength and reflectance in a patch. The spectroreflectometer 30 measures a patch and outputs a reflectance value as a color measurement result at each wavelength. As shown in FIG. 3, the color measurement results can be plotted in the diagram with the horizontal axis of wavelength and the vertical axis of reflectance. A change in reflectivity which is obtained based on reflectance at each wavelength is called “gradient” and is indicated in FIG. 3. As shown in FIG. 3, a difference in reflectivity between two adjacent wavelengths is referred to as “gradient.” Since this kind of “gradient” (change) actually affects color measurement results, the gradient is taken into consideration when the color measurement unit is calibrated in this embodiment.

FIG. 4 is a diagram in which a color measurement result read by the spectroreflectometer 30 of a reference and a color measurement result read by the spectroreflectometer 30 of a correction-target are plotted so as to make use of the difference as a correction value. Since the difference also varies in accordance with the gradient, an axis of gradient value in the depth direction is indicated in addition to the horizontal axis of wavelength and the vertical axis of reflectance. In FIG. 4, color measurement results are plotted for respective patch. That is, for each of a patch #1 and patch #2, color measurement results A read by the spectroreflectometer 30 used as a reference unit and color measurement results B read by the spectroreflectometer 30 as a correction-target are plotted, showing how a difference in reflectivity at each wavelength is determined.

In step 6, continuous correction values are created by smoothly connecting the plotted correction values. Since the spectroreflectometer 30 outputs a reflectance value as a color measurement result at each discrete wavelength, differences calculated are also discrete. Therefore, the correction values are made smooth and continuous through interpolation operation. As a method for interpolation, a linear interpolation operation, which is proportional and rectilinear, a curvilinear interpolation operation using a high-dimensional function, and the like are well-known, and any of them can be employed in the embodiment.

Note that steps 5 and 6 correspond to the steps executed in the patch difference obtaining unit.

In step 7, an operation is performed to make correspondence between the difference and the change in reflectivity at each wavelength and reflectance for all of the patches so as to plot as a correction value. Only one reflectance value is obtained as a color measurement result at a certain wavelength in each color patch measurement. However, a curve of spectral reflectance changes when a patch for color measurement is changed, and multiple curves with different gradients may appear while they pass a point of the same wavelength and same reflectance. This means that the spectroreflectometer 30, taking “gradient” as an argument element, outputs different color measurement results. In this step, each correction value is obtained first while making correspondence between the difference and the change in reflectivity at each wavelength and each reflectance. The correction values obtained in this way are also discrete.

Next, in step 8, the plotted correction values are connected smoothly to create continuous correction values.

If a large number of sample patches are provided, a sufficient number of difference values, along each axis of change in reflectivity at each wavelength and reflectance, may be obtained. However, in actuality, there are a lot of grid points without difference data as far as each of the sample patches is needed to be measured through color measurement operation.

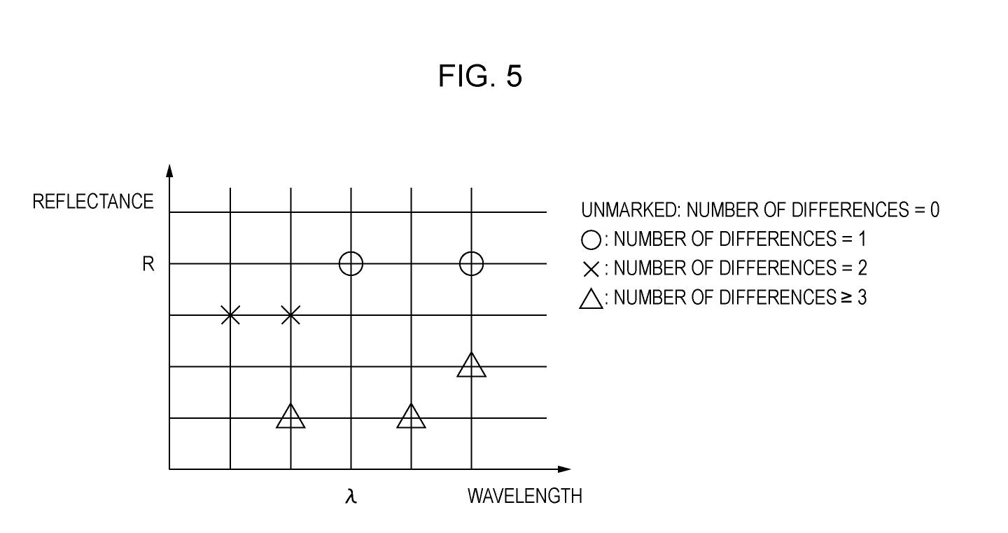

Therefore, grid points with no data are classified as described below and data for such grid points are estimated from other data. Here, FIG. 5 is a diagram indicating the number of differences at each grid point with the axes of wavelength and reflectance. As understood from the diagram, the grid points are classified as follows.

CLASS 1: The number of color measurement results (differences) is “0” at the same wavelength and reflectance.
CLASS 2: The number of color measurement results (differences) is “1” at the same wavelength and reflectance.
CLASS 3: The number of color measurement results (differences) is “2” at the same wavelength and reflectance.
CLASS 4: The number of color measurement results (differences) is “3” or more at the same wavelength and reflectance.

Colors which the printer 20 finally outputs are limited to the specified-colors on which the spectroreflectometer 30 performs color measurement. Therefore, although the color measurement is performed in principle, all grid points do not need correction values. Since an error may appear in the vicinity of a color measurement result read by the color measurement unit as a reference, it can be said that necessity of estimation is not so high in the case of CLASS 1.

Accordingly, with regard to CLASS 1, no estimation is made or estimation is made through a simple operation from the data at grid points in the vicinity of the CLASS 1 grid point. For example, a method can be cited such that each of the difference values at the grid points in the vicinity of the CLASS 1 grid point is weighted as inversely proportional to the distance therefrom and those weighted values are averaged to determine a difference value of estimation.

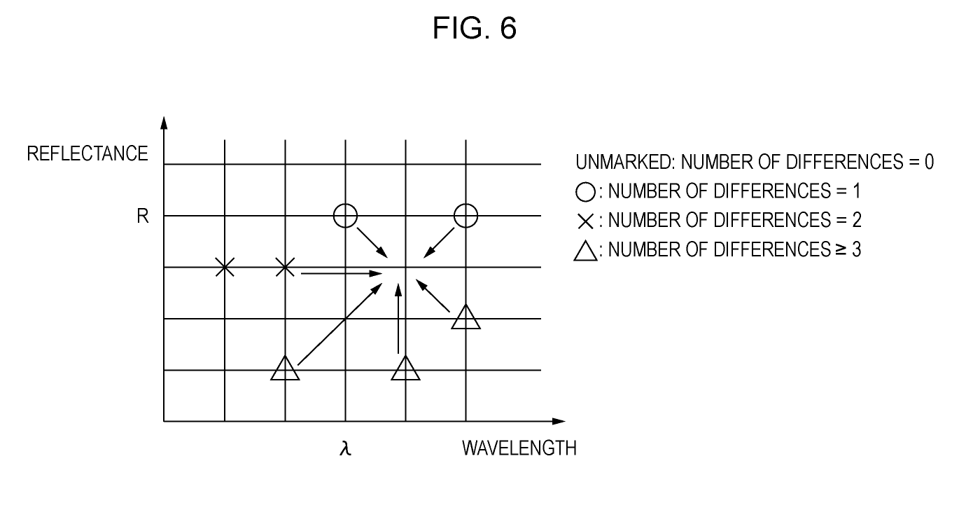

FIG. 6 indicates an operation process in which each value is weighted as inversely proportional to the distance from each of the grid points in the vicinity of the CLASS 1 grid point and those weighted values are averaged. In the grid points with no difference, these grid points are enclosed and are weighted as inversely proportional to the distance from the grid points with the difference to estimate the difference as a correction value. That is, the process for CLASS 1 is a process in which a difference at a grid point without data of wavelength and reflectance is estimated through interpolation operation from the differences at other grid points having data of wavelength and reflectance.

As for CLASS 2, it is a case in which there is just one actually-measured change in reflectivity at the grid point. Since, in this case, it is not possible to estimate color measurement results at other changes, a constant value of difference is adopted regardless of the change.

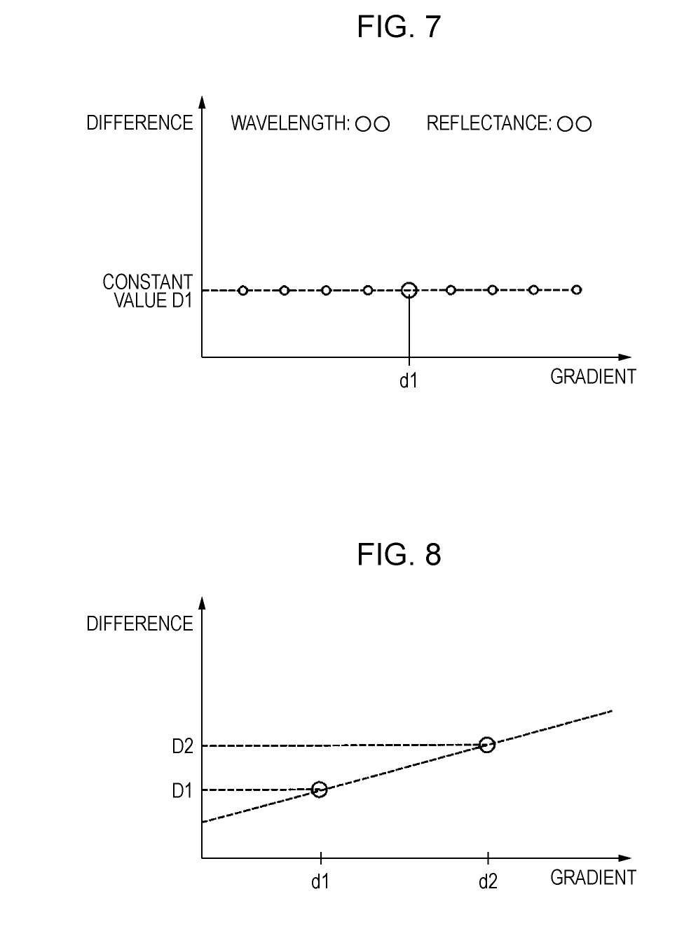

FIG. 7 indicates the case of CLASS 2, in which a constant difference value D1 is adopted for the estimation regardless of the gradient in the case when the only available difference is one at a gradient d1.

In the case of CLASS 3, since there are two color measurement results at the same wavelength and reflectance, a proportional relationship can be estimated in which the larger one is taken as the maximum sample value and the smaller one is taken as the minimum sample value. In other words, a difference between the two color measurement results (differences in reflectance) and a difference between the two respective changes are obtained to calculate a coefficient; the correction value is determined through proportion calculation using this coefficient.

FIG. 8 indicates the case of CLASS 3. When previously-determined differences are only those at gradients d1 and d2, respectively, a difference value is estimated using a changing ratio of (D2−D1)/(d2−d1). This means that a process for CLASS 3 is carried out in the following manner. With regard to a grid point that has the data of wavelength and reflectance but lacks the data of change, in the case where there are two differences with different changes, the difference of each grid point is estimated according to the change from the difference at the maximum change and the difference at the minimum change.

CLASS 4 is a case in which there are three or more color measurement results at the same wavelength and reflectance. These color measurement results are smoothly connected using a multi-dimensional function. In other words, an optimum correction value can be obtained at a certain wavelength and reflectance using the difference in reflectivity (gradient) as an argument.

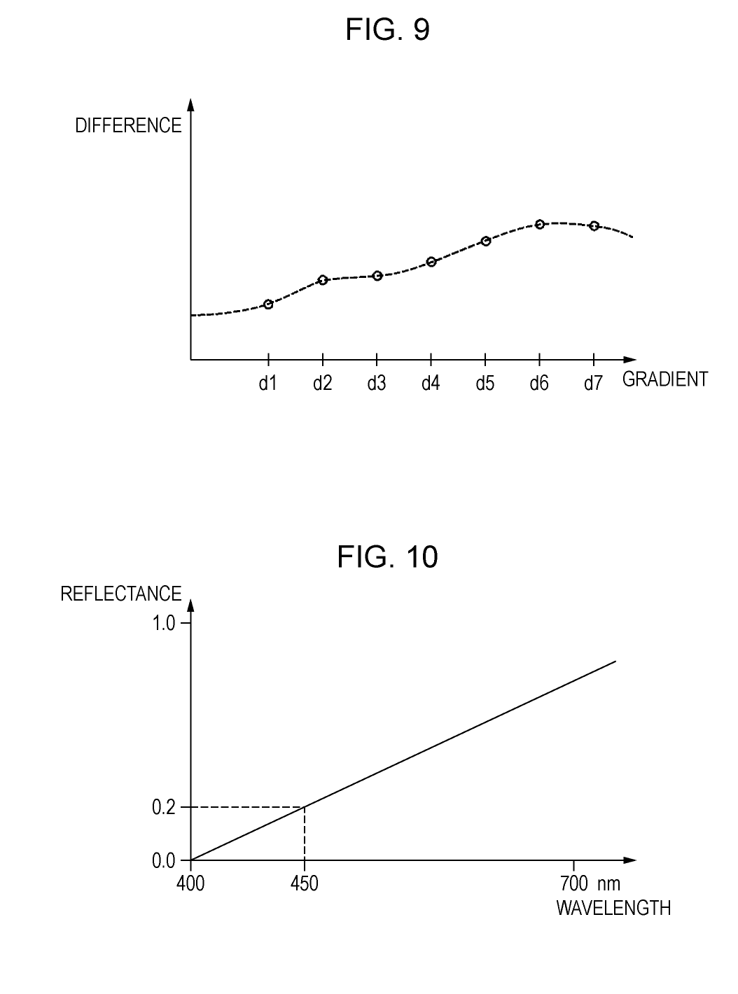

FIG. 9 indicates the case of CLASS 4, in which differences each corresponding to each gradient are connected smoothly through the interpolation method such as a multi-dimensional function to estimate continuous correction values. This means that a process for CLASS 4 is carried out in the following manner. With regard to a grid point in the correction LUT that lacks a correspondence relationship with the difference, and has the data of wavelength and reflectance but lacks the data of change, the difference is estimated by smoothly connecting the grid points based on the differences corresponding to the previously-measured changes.

As described thus far, steps 9-1 to 9-3 corresponding to CLASS 2, CLASS 3 and CLASS 4, respectively, are executed. To be more specific, step 9-1 is executed when there is one difference with respect to the same wavelength and reflectance and this difference is adopted without exception regardless of the change in reflectivity.

Step 9-2 is executed when there are two differences with respect to the same wavelength and reflectance. By making use of the difference at the maximum change in reflectivity and the difference at the minimum change in reflectivity, a difference value in proportion to the change is calculated. At this time, the difference value in proportion to the change should be broadly interpreted. For example, a difference value may be calculated automatically by multiplying the change by a coefficient. On the other hand, with the changes being set discretely, different values each corresponding to each of the discrete changes may be prepared. That is, changes are categorized into a large, middle, and small range, to each of which a constant difference is assigned. Furthermore, step 9-2 includes processing in which a fluctuation range of the difference value is limited beforehand so as to suppress the fluctuation range of the difference value from expanding excessively even if the absolute value of the change becomes larger.

Step 9-3 is executed when there are three or more differences with respect to the same wavelength and reflectance. The interpolation operation using a multi-dimensional function is performed so as to smoothly connect the differences.

Thus, because the correspondence relationship between the changes in reflectance to a wavelength change and the differences is specified, steps 7, 8, 9-1, 9-2, and 9-3 correspond to the steps executed in the change-in-reflectivity difference obtaining unit.

As described thus far, correction values for each of the grid points are determined. As a result, in step 10, a three-dimensional LUT is created including a wavelength, reflectance, a change in reflectivity (gradient), as its argument elements. Note that step 10 corresponds to the correction LUT creation unit.

By making use of a correction LUT for referring to a correction value which corresponds to a difference between the color-measurement value measured by a reference color measurement unit and the color-measurement value measured by a correction-target color measurement unit, a skew of color from the reference value can be detected when a color measurement unit mounted in a printing apparatus measures a printed material output by the printing apparatus. Then, a correction unit that feeds back the color measurement result after correcting the detected skew mentioned above to print data of the printing apparatus can be implemented. An actual correction unit can be implemented in many ways; parameters for the correction may be reserved in the printer driver and be applied at the time of printing.

### 3. Modifications

In the above embodiment, although a three-dimensional correction table is created, a higher dimensional correction table may be created. In addition to the change in reflectivity (gradient), a change of the change in reflectivity, i.e., a gradient of the gradient may be added as a new argument element. This modification example is such that the correction LUT includes, as its argument elements, a wavelength, reflectance, a change in reflectivity relative to wavelength, and a change of the change in reflectivity.

In the embodiments described above, it is assumed that all the color-measurement values obtained by color measurement operation should be used. However, in actuality, there exists a region where accuracy of color measurement is low in nature. For example, a color measurement result of low reflectance shows poor accuracy. Low reflectance means that color measurement is performed on dark reflected light, consequently the accuracy of the color measurement becomes low. Therefore, it does not contribute to the improvement in accuracy to carry out rigorous calculation for correction values in the region where low reflectance is inevitably obtained.

To cope with such a situation, calculation for a correction value may be omitted when a color measurement result under a threshold value of reflectance, for example, less than “0.2” is obtained. In other words, because the improvement in accuracy cannot be expected, the correction operation will not be carried out.

For this reason, this modification example corresponds to a process in which color measurement results obtained in the region of low brightness are less weighted in estimation of the correction values.

FIG. 10 schematically indicates a relationship between a wavelength and reflectance. As shown in FIG. 10, sensitivity of color measurement tends to be low in a region where the wavelength is relatively short, and accuracy of color measurement is especially low when the wavelength is less than 450 nm. Therefore, in such a region, calculation to obtain correction values may also be omitted and consequently no correction may be applied.

With regard to the category of invention, it is easily recognized that the spirit of the apparatus invention is equally effective in other categories of invention. Accordingly, it is also understood that the invention discloses inventions in other categories, such as a method, a program recording medium, and a program; these inventions are not all disclosed in the appended claims of the invention, but can be easily introduced from the embodiments.

The invention is not limited to the above described embodiments and modifications. A configuration in which the components which have been disclosed in the embodiments and modifications are replaced by each other or re-combined with each other, a configuration in which the components which have been introduced as a known technique or disclosed in the embodiments and modifications are replaced by each other or re-combined with each other, and the like can be thought of However, these configurations are also within the scope of the invention.

What is claimed is:

1. A printing apparatus comprising:
a printing unit that prints a patch;
a first color measurement unit that radiates the patch with a plurality of different wavelength lights and receives reflected light;
a computing unit that computes, based on the reflected light, reflectance of the patch and a change in reflectivity of the patch relative to each of the plurality of different wavelength lights;
a memory unit that stores the change in reflectivity of the patch relative to each of the plurality of different wavelength lights, the change in reflectivity being obtained by a second color measurement unit, different from the first color measurement unit, radiating the patch with the plurality of different wavelength lights; and
a correction unit that corrects the reflectance computed by the computing unit, based on the change in reflectivity relative to each of the plurality of different wavelength lights computed by the computing unit and the change in reflectivity relative to each of the plurality of different wavelength lights stored in the memory unit.

2. The printing apparatus according to claim 1;
wherein the correction unit does not correct the reflectance of the patch computed by the computing unit if the reflectance is measured at the wavelength shorter than a predetermined wavelength.

3. A printing method using a printing apparatus, comprising;
printing a patch;
color-measuring reflected light using a first color measurement unit by radiating a patch with a plurality of different wavelength lights to receive the reflected light;
computing reflectance of the patch and a change in reflectivity of the patch relative to each of the plurality of different wavelength lights based on the reflected light; and
correcting the reflectance computed by the computing, using the change in reflectivity of the patch relative to each of a plurality of different wavelength lights previously stored in a memory unit and the change in reflectivity relative to each of the plurality of different wavelength lights computed by the computing, the change in reflectivity stored in the memory unit being obtained by a second color measurement unit, different from the first color measurement unit, radiating the patch with the plurality of different wavelength lights.

4. A storage medium storing a computer-readable program that causes a computer to execute:
printing a patch;
color-measuring reflected light using a first color measurement unit by radiating a patch with a plurality of different wavelength lights to receive the reflected light;
computing reflectance of the patch and a change in reflectivity of the patch relative to each of the plurality of different wavelength lights based on the reflected light; and
correcting the reflectance computed by the computing, using the change in reflectivity of the patch relative to each of a plurality of different wavelength lights previously stored in a memory unit and the change in reflectivity relative to each of the plurality of different wavelength lights computed by the computing, the change in reflectivity stored in the memory unit being obtained by a second color measurement unit, different from the first color measurement unit, radiating the patch with the plurality of different wavelength lights.
